(19) United States
(12) Patent Application Publication
(10) Pub. No.: US 2012/0269029 A1
(43) Pub. Date: Oct. 25, 2012

(54) PROGRAMMABLE MIXER AND METHOD FOR THE OPERATION THEREOF

(75) Inventors: Matthias Konietzko, Bamberg (DE); Albrecht Konietzko, Bamberg (DE)

(73) Assignee: GAKO KONIETZKO GMBH, Bamberg (DE)

(21) Appl. No.: 13/497,867

(22) PCT Filed: Sep. 17, 2010
(86) PCT No.: PCT/EP2010/063676

§ 371 Date: Mar. 23, 2012

(30) Foreign Application Priority Data
Sep. 23, 2009 (DE) 102009044077.1

(51) Int. Cl. B01F 7/16

(52) U.S. Cl. 366/286

(57) ABSTRACT

The invention relates to a programmable mixer for producing pharmaceutical or cosmetic recipes. The mixer includes a controller, a motor-driven mixing unit having a mixing tool engaging in a mixing vessel, and a lift unit. The lift unit induces an axial relative motion between the mixing tool and the mixing vessel to displace the mixing tool in the mixing vessel at a constant lift speed. The control method includes counting the lift strokes performed by the lift unit during an initial mixing process for each mixing period, and using the identifying data determined in the initial mixing process during a repeated mixing process. The identification data matching the recipe are read in, and the number of lift strokes per mixing period determined in the initial stirring process is used for implementing the corresponding mixing period of the repeated mixing process.

### BACKGROUND

The invention relates to a procedure for controlling a program-controlled mixer for production of pharmaceutical or cosmetic recipes or formula. Additionally the invention comprises a mixer for implementing such a process. Generic mixers comprise a control unit, a motor-driven mixing unit having a mixer tool which engages into a mixing vessel, and a lift unit. The lift unit causes an axial relative motion between the mixing tool and mixing vessel, to shift the mixing tool in the mixing vessel between an upper and a lower end position at a constant lift speed.

For example, in medical facilities, individual pharmaceutical and cosmetic recipes or formula of salves, powder mixtures, gels and the like are produced. When such recipes are individually produced, as is customary in pharmacies, according to customary methods the components of the recipes are manually mixed with each other. Along with the danger that the substances to be produced will be contaminated, there is also the problem that the conditions under which the individual materials are mixed cannot be reproduced and are not documentable. The result is substantial qualitative differences during manufacture of the same recipe, which at minimum can have an effect on the effectiveness of the recipe.

Recent times have seen increased use of program-controlled mixers even in pharmacies, because they make it possible to provide highest-quality recipes that remain constant, even with repeated manufacture.

From DE 196 41 972 C1 a mixer is known for stirring, mixing, comminution and the like, which has a mixing unit and a lift unit, to do partially automated mixing of certain substances with a mixing tool in a mixing container, so that the result is the desired recipe. With this device it is possible to manually vary the mixing speed, mixing time, lift stroke and lift speed within certain limits, to adapt them to special kinds of recipes. The disadvantage of this known device is that the optimal parameters of various mixing processes cannot be stored in memory, and thus are not available over a long period of time and thus must be newly inputted every time the recipe is made.

From DE 31 26 552 A1 a method is known for controlling mixing processes. With this, using the viscosity of a substance, the optimal power consumption of the mixing device is governed. In addition, the viscosity can be continuously measured during the mixing process.

From EP 1 324 820 B1, a method is known for employing a program-controlled mixer, in which initially variable and constant data can be read in. The variable data define the category of the recipe to be produced as well as the size of the mixing vessel or the amount of the recipe. The constant data are preset in a data storage device and contain base values for the mixing time and mixing speed for various categories of recipes and sizes of mixing vessels. From the data read in, the mixing time and mixing speed for production of the desired quantity of the recipe are determined by linkage of the variable and constant data. With the data determined, the mixing unit is appropriately governed and the recipe is produced. After the recipe has been produced, the control parameters used are stored in a computer storage device for later production of the same recipe in the same quantity, together with data identifying the recipe produced. In addition the control parameters used and/or identifying data are issued in electronic or hard-copy form via data transmission devices. For individual recipes for which no base values have been stored in the memory, or these are not to be carried over unaltered, the user must individually program the mixing time and r.p.m. of the mixing tool. If, at a later time, an altered quantity of such an individual recipe is needed, the operator must determine new values at least for the mixing time. By this means the quality of the recipe produced can vary depending on the amount produced, which is not desired.

### SUMMARY

The task that is the basis of the invention is to reproducibly create individual recipes that were once manufactured or standard recipes, independent of the amount of recipe or size of the mixing vessel to be used, with a quality that remains constant.

The problem is solved by a method for controlling a program-controlled mixer with the features of patent claim 1 and by a program-controlled mixer with the features of claim 8.

### DETAILED DESCRIPTION

A program-controlled mixer with which the inventive method can be used, first of all comprises in known fashion a control unit, a motor-driven mixing unit with a mixing tool, which engages into a mixing vessel, and a lift unit. The lift unit produces an axial relative motion between the mixing tool and mixing vessel, to move the mixing tool in the mixing vessel between an upper end position and a lower one, preferably at a constant lifting speed.

According to the inventive method, the steps described in what follows are carried out:

First an initial mixing process is carried out for an initial recipe, wherein input values or preset values are used at least for the mixing time and the r.p.m. of the mixing tools for each mixing period. Preferably up to six consecutive mixing periods can be used with this.

During this initial mixing period, the lift strokes performed by a lift unit moving preferably at constant speed are counted for each mixing period. Depending on the definition, one lift stroke is understood to be the full axial displacement of the mixing tool between the upper and lower end position in the mixing vessel, or between two identical end positions. By counting the lift strokes made during the initial stirring process, an especially simple and effective repeated mixing process is possible, even for various quantities and sizes of mixing vessels, in that in the repeated mixing process, the number of lift strokes is repeated at the appropriate r.p.m., without needing to recalculate for a different quantity or size of the mixing vessel.

No scaling or recalculation is necessary to attain an optimum mixing result, even if the quantity is changed.

Then the identifying data for the initial recipe are stored in computer memory. These identifying data at minimum include the previously determined number of lift strokes per mixing period and the r.p.m. per mixing period. For this it is not necessary that, for example, the number of lift strokes be contained in the identifying data as an unchanged numerical value. For example, the number of lift strokes determined can be encoded in a code or recalculated while using certain factors into a time indication and then added to the identifying data. Additionally, the size of the mixing vessel can be stored with the identifying data. This, however, is not absolutely necessary.

In an especially preferred embodiment of the invention, the input values for compilation of the initial recipe are inputted for the overall mixing process, with preliminary adjustments already selected with the input. The input here is preferably done as follows: input of the size of the mixing vessel (or amount of the recipe to be manufactured) and then input of the mixing speed (for example, by inputting the r.p.m. to be used) and mixing time per mixing period. An internal storage site or a so-called identification number can also be used for the input, with these inputted values being stored in encoded fashion.

If this initial recipe is to be produced again in another issued amount, a repeated stirring process is carried out, wherein according to the invention, the lift stroke number per mixing period determined in the initial mixing process is used, independent of the size of the mixing vessel and the amount of the recipe. For this, the previously stored identifying data are used. The identifying data are either read in from the internal storage device or by inputting an identification number.

It was surprising to find that reproduction of a recipe with the lift stroke number per mixing period determined in the initial mixing process led to a very good mixing result, independent of the size of the mixing vessel used and of the amount of the repeated recipe. No scaling calculations, or else very simple ones, are needed for repeated manufacture of the recipe in an altered quantity.

The advantages of the invention are especially seen in that at various quantities of the mixing vessel or quantity of the recipe to be manufactured, no scaling is required over the time of the individual mixing periods. The quality of the manufactured recipe is independent of the manufactured amount, owing to the invention-specific dispensing with manual scaling of the mixing time and instead of that, control of the mixing time via the lift stroke number recorded during the initial recipe. Results that remain identical are also achieved if the mixing vessel is filled with more or less of the substance in the repeated mixing process.

Due to the differing rotational velocities at the edge of the mixing tool at various quantities of mixing vessels, scaling for different mixing vessels with the lift stroke number remaining the same is totally dispensed with. By use of larger mixing tools, for a result that stays equally good, less mixing time is needed, for example, for a recipe with 300 ml than for a recipe with 50 ml. Due to the fact that with larger mixing vessels, a higher angular velocity is achieved at the tips (outer ends) of the mixing tool (preferably a wing-shaped mixer) at the same r.p.m. of the mixer motor, the energy input per gram of a recipe with a larger mixing vessel with the same lift stroke number remains at least as high, if not even higher. In the result, the quality is at least as good, if not even better, than with a smaller mixing vessel.

Since with larger mixing vessels, the lift stroke length is greater, the mixing time is scaled semi-automatically. This is especially advantageous in using mixing vessels with a slidable base. The actual amount of the recipe does not need to be determined and recalculated to the required mixing time, because the lift unit automatically detects the upper and lower end position (or these are manually set) and by the shortening of the lift stroke with the shifted base, the mixing time by counting the lift strokes performed is automatically adjusted to the effectively used size of the mixing vessel. For the first time, quality that remains equally high is also ensured if larger mixing vessels are not completely filled, and adaptation by the operator of the mixing time is dispensed with.

In a preferred embodiment form of the invention, the identifying data are transmitted after the initial mixing process. This can be done on a monitor or, for example, on a printer. The output can be as an encoded combination of numbers or letters, or, for example, as a bar code or quadratic Aztec code that is printed on a label or issued on a monitor and if necessary stored in a computer memory.

In another preferred embodiment form of the invention, modified identification data are issued. These can, for example, be printed out (a combination of letters and numbers, a bar code, or an Aztec code) or issued in some other manner (USB, memory card . . . ). Such modified identifying data are issued as a so-called identification number, for example with the following data:
The size of the mixing vessel with decimal numbers indicated from 1 to 9 (1: 15 ml, 2: 20 ml, 3: 30 ml, 4: 50 ml, 5: 100 ml, 6: 200 ml, 7: 300 ml, 8: 500 ml, 9: 0 to 500 ml).
The next data item comprises the r.p.m. and the time duration pertinent to it for a mixing period. The r.p.m. preferably can be issued in gradations between 0 and 2400 revolutions per minute in 10 stages.
Overall, six mixing periods, for example, can be recorded. The time duration of the individual mixing periods is to orient the user of the mixing device and is not relevant for reproduction of the recipe. But customarily the user is oriented to mixing times, so that these are easier for him to reconstruct than data on numbers of lift strokes. For the purpose of outputting the modified identifying data, the duration of the mixing periods is determined from the stored number of lift strokes at a known lift speed. Thus, mixing time measurement can be dispensed with when carrying out the mixing process. The time values issued to the user are calculated by the device from the determined number of lift strokes and stored as identifying data.
An additional component of the identification number is the overall number of lift strokes performed.

For each identification number, the device preferably stores additionally the de-facto number of lift strokes per mixing period. This can also be issued separately.

In carrying out the repeated recipe, the mixer or the mixing unit is controlled by the r.p.m. preset via the identifying data per mixing period, wherein in each mixing period, the lift strokes of the lifting unit are counted and when the lift stroke number of the initial mixing process has been reached, the next mixing period commences.

The identifying data (identifying number) can be inputted when manufacturing a repeated recipe via a keyboard or some other input medium like a scanner, memory card or the like.

A scaling function is only needed if certain r.p.m. are not available due to the size of the mixing vessel. With large mixing tools, very large r.p.m. cannot be used, if undesired forces must be avoided due to imbalances. For this reason, it is advantageous if, at the start of a repeated mixing process, the actual mixing vessel size is determined (for example, via lift stroke length), or inputted (for example, via the amount of the recipe), so as not to operate the large mixing tools required in large mixing vessels at impermissibly high r.p.m. Here it should be recalled that the mixing tools of such devices are adjusted to the diameter of the mixing vessels, make possible frictional processes at the walls, and to attain a complete, uniform mixing of the product for mixing. Preferably a safety function in the mixer ensures that operation is precluded at excessively high r.p.m.

If thus the maximum r.p.m. level has been determined for a certain mixing vessel size, then a correction factor must appropriately increase the number of lift strokes, if a lowered r.p.m. must be employed as compared to the initial mixing process. Programs that, for example, for 50 ml at an r.p.m. level of 8 or 9 make provision for a lift stroke number of 10, would then for 300 and 500 ml (at this size, an r.p.m. level of 8 or 9 is prohibited) run a lift stroke number of 12 and 14, respectively, for an r.p.m. of 7. The scaling can be described by a mathematical connection and be carried out by the microprocessor of the mixer. Also, the placement of a value table into memory is possible, which can be referred back to for the scaling.

To assign a suitable modified identification number to a certain mixing vessel, after the mixing process is completed, the operator can be queried as to the size of the mixing vessel used, or the size is determined by appropriate sensors. But for further reproductions it is not absolutely necessary to place another identification number with another size of mixing vessel into storage, as long as the data from the initial mixing process are known.

In another preferred embodiment form of the invention, at the end of the repeated mixing process, a check can be done of whether at least the overall lift stroke number of the initial mixing process or the determined lift stroke number were attained per mixing period. If the requisite lift stroke numbers have not been attained, a warning signal can be issued, which instructs the operator to check the quality of the recipe.

1. A method for controlling a program-controlled mixer for repeated production of pharmaceutical or cosmetic recipes, wherein the mixer comprises:
a control unit;
a motor-driven mixing unit with a mixing tool, which engages in a mixing vessel;
a lift unit, which produces an axial relative motion between the mixing tool and mixing vessel, to displace the mixing tool in the mixing vessel between an upper end position and a lower end position, with a constant lift stroke speed;
wherein the method comprises the following steps:
implementing an initial mixing process for an initial recipe, using input values and/or preset values at least for the mixing time and an r.p.m. of the mixing tool per mixing period;
counting the lift strokes performed per mixing period by the lift unit during an initial mixing process;
storing into memory identifying data that contain at least the counted number of lift strokes per mixing period and the r.p.m. per mixing period;
implementing a repeated mixing process for a repeated recipe while using at least the identifying data determined in the initial mixing process, with the identifying data suitable for the recipe being stored and the number of lift strokes counted in the initial mixing process being used identically or scaled to implementation of corresponding mixing periods for the repeated mixing process.

2. The method according to claim 1, wherein the identifying data are issued after the initial mixing process.

3. The method according to claim 1, further comprising issuing modified identifying data that includes the r.p.m. and mixing duration per mixing period, with the mixing duration being determined from the determined lift stroke number per mixing period and the preset lift stroke speed.

4. The method according to claim 3, wherein the modified identification data additionally comprise the size of the mixing vessel and the overall lift stroke number.

5. The method according to claim 1, further comprising determining the upper and lower end position of the mixing tool from the size of the mixing vessel.

6. The method according to claim 5, wherein the upper and lower end position of the mixing tool in mixing vessels with a slidable base is determined from the position of the base.

7. The method according to claim 1, further comprising using a scaling function for adjustment of the lift stroke number, if certain r.p.m.s are prohibited for certain sizes of mixing vessels.

8. A program-controlled mixer with a control unit, a motor-driven mixing unit with a mixing tool which engages into a mixing vessel, and a lift unit that causes an axial relative motion between the mixing tool and mixing vessel, to displace the mixing tool in the mixing vessel between an upper end position and a lower end position at a constant lift stroke speed, wherein the program-controlled mixer is configured to carry out a procedure according to claim 1.

9. The mixer according to claim 8, further comprising means for determining the lift strokes of the lift unit made during individual mixing periods, and means for storing and issuance of these determined lift stroke numbers together with r.p.m.s used.

10. The mixer according to claim 9, further comprising means for scaling a lift stroke number, which causes an increase in the preset lift stroke number by a scaling factor, if the r.p.m. assigned to the preset lift stroke number of the stirring tool is not possible.
